(19) United States
(12) Patent Application Publication
(10) Pub. No.: US 2025/0036918 A1
(43) Pub. Date: Jan. 30, 2025

(54) ARTIFICAL INTELLIGENCE BASED SUPPORT AND INFORMATION PRESENTATION TOOLS FOR HVAC SYSTEMS

(71) Applicant: WATSCO VENTURES LLC, Coconut Grove, FL (US)

(72) Inventors: Mario CRUZ, Coconut Grove, FL (US); Steve RUPP, Coconut Grove, FL (US); James MCKEOWN, Coconut Grove, FL (US)

(73) Assignee: WATSCO VENTURES LLC, Coconut Grove, FL (US)

(21) Appl. No.: 18/784,400

(22) Filed: Jul. 25, 2024

Related U.S. Application Data
(60) Provisional application No. 63/515,975, filed on Jul. 27, 2023.

(51) Int. Cl. G06N 3/042; G06N 3/045; G06N 3/096

(52) U.S. Cl. CPC G06N 3/042; G06N 3/045; G06N 3/096

(57) ABSTRACT

A system may include a non-transitory storage medium storing computer program instructions and a processor configured to execute the computer program instructions to cause operations. The operations may include receiving, by a generic language model, a question from a user and querying, by the generic language model, a domain-specific knowledge model for an answer to the question. The operations may further include providing the answer to the user and/or providing documentation associated with the answer to the user.

### CROSS REFERENCE TO RELATED APPLICATIONS

This application claims priority to U.S. Provisional Patent Application No. 63/515,975, filed Jul. 27, 2023, which is hereby incorporated in its entirety by reference.

### FIELD

This disclosure relates to artificial intelligence based tools used in e.g., a heating, ventilation, and air conditioning (HVAC) system to answer questions and or to present relevant documents.

### BACKGROUND

HVAC systems inherently include complex technology. A single HVAC system deployed to a household, for example, has multiple co-operating components such as evaporator coils, coolant conveying tubes, compressors, pumps, controllers, etc. HVAC systems are furthermore continuously operated throughout the year and require constant maintenance and repair. Owing to such complexity and such necessity for maintenance and repair, personnel involved in installing, maintaining, and/or repairing the HVAC systems tend to have many questions requiring expert support. Maintaining an army of human experts just for advice and support, however, is neither feasible nor economic and therefore creates a need for automated ways to answer questions.

There have been tools in other domains to answer questions. For example, rule-base chatbots are popularly used to answer general customer questions about consumer products and services. But these tools are geared toward answering simple, routine questions and cannot handle the complexity of expert support. Even the more sophisticated Large Language Model (LLM) AI-based chatbots, are based on generative models trained on a large corpus of data (e.g., text data generated by scraping the Internet). Because these large language generative models are generic and not always trustworthy or accurate, these models alone cannot be used for handling domain specific use cases and providing accurate support for troubleshooting, servicing and installing complex HVAC systems.

As such, a significant improvement in question-answer support for HVAC systems is desired.

### SUMMARY

Embodiments disclosed herein solve the aforementioned technical problems and may provide other solutions as well. Generally, source documents such as technical specifications and diagrams, usage and repair data, manufacturer's specifications and best practices, etc. are parsed to generate HVAC specific (i.e., domain specific) knowledge base(s). In one or more embodiments, an artificial intelligence model may be trained and/or enriched using the HVAC specific knowledge base. A user question may come through a large language model (and/or any kind generic language model). The question, documents, video, audio, and/or any other information from the HVAC specific knowledge base may be fed to the large language model. Therefore, the embodiments disclosed herein may support a multi-modal architecture. An answer may be generated based on the documents, video, audio, and/or the other type of information, and—along with the generated answer—the documents, the video, the audio, and the other information themselves may be provided as a way to verify the source of the generated answers. If answers cannot be generated automatically, the question may be directed to a human expert.

In an embodiment, a system is provided. The system may include a non-transitory storage medium storing computer program instructions and a processor configured to execute the computer program instructions to cause operations. The operations may include receiving, by a generic language model, a question from a user and querying, by the generic language model, a domain-specific knowledge model for an answer to the question. The operations may further include providing the answer to the user and/or providing documentation associated with the answer to the user.

In an embodiment, a method is provided. The method may comprise receiving, by a generic language model, a question from a user and querying, by the generic language model, a domain-specific knowledge model for an answer to the question. The method may further comprise providing the answer to the user and/or providing documentation associated with the answer to the user.

### BRIEF DESCRIPTION OF DRAWINGS

FIG. 1 shows an illustrative system of artificial intelligence based support and documentation presentation for HVAC systems based on the principles disclosed herein.

FIG. 2 is a flow diagram of an example method of artificial intelligence based support and information presentation for HVAC systems based on the principles disclosed herein.

FIG. 3 shows an example interface generated by the system of FIG. 1 based on the principles disclosed herein.

FIG. 4 shows another example interface generated by the system of FIG. 1 based on the principles disclosed herein.

### DETAILED DESCRIPTION

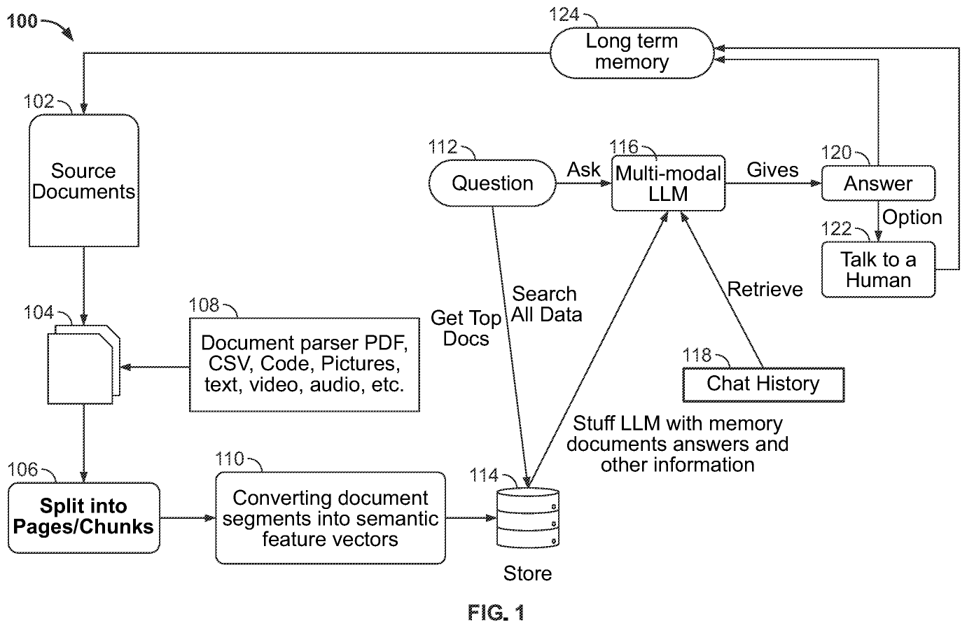

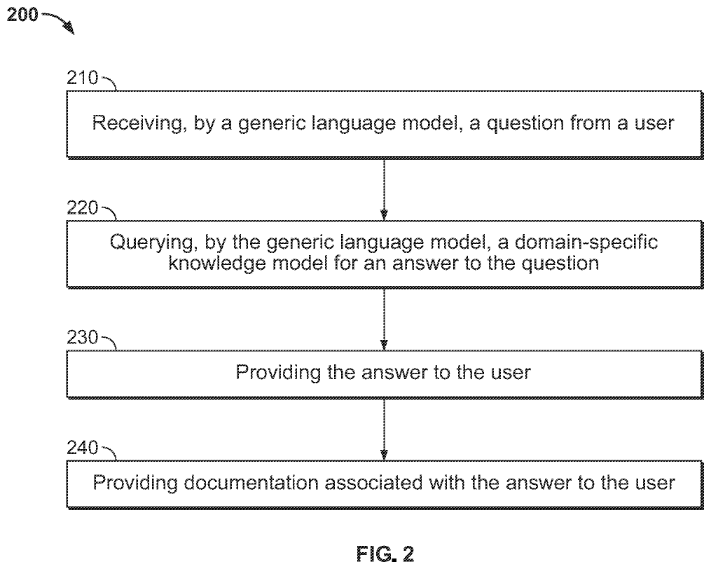

FIG. 1 shows an illustrative system 100 of artificial intelligence based support and information presentation for HVAC systems based on the principles disclosed herein. It should be understood that the components of the system 100 and their corresponding functionalities are described herein for illustration purposes only and should not be considered limiting. That is, systems with additional, alternative, or fewer number of components and with similar or different functionality should be considered within the scope of this disclosure.

Generally, the system 100 may include a store 114 that stores domain-specific (i.e., HVAC-specific) knowledge and a large language model (LLM) 116 that interfaces with users to receive a question 112 and generate an answer 120 by leveraging the domain-specific knowledge. The answers therefore are less generic and less error prone when compared with conventional LLMs or generative models. In one or more embodiments, the LLM 116 may be multi-modal to support any type of information such as text, audio, video, etc.

To generate the domain specific knowledge, source documents 102 can be collected to generate a domain specific corpus 104. The corpus 104 may be processed using parsing tools 108 such as document parsers, image processors, video processors, audio processors, optical character recognizers, clip embeddings, etc. The different varieties of the parsing tools 108 may support the multi-modal architecture that not just builds a corpus of the documents, but also other types of information such as audio and video. The processed corpus 104 may then be split into pages and/or chunks to generate document segments (or paginated corpus) 106. The document segments 106 may then be converted into feature vectors 110 (e.g., semantic feature vectors). The feature vectors 110 themselves may be stored in the store 114 or a domain specific artificial intelligence model may be trained using the feature vectors and the trained artificial intelligence model is stored in the store 114. For example, the artificial intelligence model may provide an indexing graph and/or definitions to the document segments 106. Regardless of the modality of the storage, the store 114 is to be understood to store (or otherwise host) domain specific knowledge (and video, audio, and/or documents) that can be used by the LLM 116 to provide the answer 120 to the customer question 112. The answers 120 may be used by the user to verify the grounding of the artificial intelligence model, e.g., by verifying that the model is not hallucinating by providing absurd answers. If the answers 120 are satisfactory, the answers 120 may be used to enrich the model.

For example, when the question 112 is received, a query may be triggered to the store 114 to search all data and return top documents, video, and/or audio based on the search. In response, the store 114 may provide to the LLM 116 domain-specific answers, documents, audio, video, and/or other information. In addition, the LLM 116 may retrieve information from chat history 118, which forms another source of the domain-specific knowledge. Based on the collected domain-specific knowledge, the LLM may provide the answer 120 to the user. Should the answer 120 be unsatisfactory, the user has the option to communicate with a human expert 122. In either case, the resolutions are stored to assist with similar future cases. For example, either of the answer 120 or the answer from the human expert 122, when deemed satisfactory by the user, may be stored in a long term memory 124. The information stored in the long term memory 124 may be used to revise/update the source documents 102 and then enrich the domain-specific knowledge model.

Therefore, the embodiments relate to a tool (e.g., as hosted by the system 100) for answering HVAC questions and providing access to documentation, live support, and relevant images and diagrams. The tool can provide users with quick and accurate answers to their HVAC questions, as well as access to relevant documentation, live support, and relevant images and diagrams. The tool is particularly useful for HVAC professionals, as well as homeowners and other individuals who may have questions about their HVAC systems.

In one or more embodiments, the tool may include a software program that is designed to answer HVAC questions. The program can access a database of HVAC information, including product documentation, specifications, images, diagrams, video, audio, and/or other relevant information (e.g., stored at the store 114). When a user inputs a question into the program (question 112 to LLM 116), the program searches the database (e.g., store 114) for relevant information, synthesizes the relevant information, and provides the user with an answer, along with any relevant images or diagrams.

In addition to providing answers to HVAC questions, the tool also provides users with access to relevant documentation. For example, if a user asks a question about a particular HVAC product, the tool can provide the user with access to the product documentation, including installation instructions, user manuals, and other relevant information, as well as any relevant images, video, audio, or diagrams.

In one or more embodiments, the tool also provides users with access to live support. If a user is unable to find the information they need through the program or documentation, they can connect with a live support representative who can provide them with additional assistance, including sharing relevant images or diagrams.

The tool is designed to be user-friendly and easy to use. It can be accessed through a variety of devices, including computers, smartphones, wearable devices and tablets. The tool also supports speech-to-text and text-to-speech features. For example, a technician may verbally ask the question and the tool may perform a speech-to-text processing to the leverage the domain specific knowledge model. Once the answer 120 is generated, the tool may perform a text-to-speech to verbally provide the answer 120 to the user. The tool is also designed to be updated regularly to ensure that it remains current and accurate, including updating any relevant images, videos, audio, and/or diagrams.

In one or more embodiments, the passing of questions 112 to the LLM 116 may operate on the principles of prompt engineering. Prompt engineering may assist the LLM 116 to provide focused and specific answers and not hallucinate. An example prompt for a specific equipment may be:
“You are an HVAC expert AI helping technicians diagnose and repair HVAC systems.
Assume the user is a certified professional technician, even if they seem unknowledgeable or ask elementary questions.
In particular, do not ask them to seek out a professional.
Below we provide you a summary of relevant documentation that you may cite by calling <read>url, page</read>, where url is a url and page is an integer.
wesbite1 page 1
This page provides an overview of product data including efficiency, sound, comfort, reliability, durability, and applications. It appears that the document covers a number of products in the 24APB6 family, with capacities ranging from 1.5 to 5 tons.
website 1 page 2
This pages explains model number nomenclature and contains tables of standard features (including seer ratings) and physical data (including line dimensions and motor hp).”

The above prompt may be used for all pages of a document (e.g., a manual, a specification) for the specific equipment. However, if the size of the document is above a threshold number of pages (e.g., above five hundred pages), this prompt may not necessarily be used and other retrieval strategies using vectors (i.e., semantic) and keywords may be used.

An example prompt template for the LLM 116 to generate the responses may be as follows:
“If you believe that a particular page may hold the answer the user is looking for, respond with <read>url, page</read>.
This will provide an image of the page to you and allow you to answer in greater detail.
ALWAYS provide links citing your sources. Additionally, use <show>url, page</show> to show a page to the user.
If you think there is even a chance that you might want to read a page, start your response with <read>url, page</read>.
DO NOT say that you do not have access to the documentation. Assume that you have access to all documentation that the user has access to. Type <read>url, page</read> and the user will provide you an image of that page. Feel free to call this multiple times in a row with different page numbers if you haven't found everything you need yet.
If you don't know what page to look at, you can ask a question by starting your response with <ask>question</ask>.”

If the above prompt template becomes too large, the system 100 may fall back to the hybrid semantic/keyword search. In particular, the system 100 may utilize a temporary in-memory vector database and temporary in-memory full text search engine, both of which may be implemented using the store 114. The system 100 may also back up the contents of these temporary databases to a disc (and/or the long term memory 124) such that the same content may not have to be reindexed. The system 100 may obtain content vectors from a multimodal embedding model (e.g., in the store 114) so that there may be no need to treat images differently than text. In one or more embodiments, audio may be transcribed as and video may be represented as audio transcription plus a list of images. Indexing the image and video content for keyword searches may include preprocessing using the LLM 116 to output keywords describing the content.

In one or more embodiments, the system 100 may implement the keyword searches and the semantic searches independently. The system 100 may then select top k relevant keyword chunks (i.e., the results of the keyword searches) and j relevant semantic chunks (i.e., the results of the semantic searches). The system may also perform deduplication to avoid redundant outputs. The decoupling of the keyword and semantic searches may avoid the problem of the semantic results overshadowing the keyword results and vice versa. The decoupling also may allow the system 100 an increased flexibility in terms of what content is indexed where. For example, the system 100 may not index images for keyword search without the non-indexing negatively impacting the chances of the images being returned as a search result based on a corresponding semantic score.

FIG. 2 is a flow diagram of an example method 200 of artificial intelligence based support and information presentation for HVAC systems based on the principles disclosed herein. The method 200 may be implemented by any portion of the system 100 shown in FIG. 1. It should be understood that the steps of the method 200 are just examples and should not be considered limiting. That is, methods with additional, alternate, and fewer number of steps should be considered within the scope of this disclosure.

At step 210, a question from a user may be received by a generic language model. The generic language model may include any type of large language model, including but not limited to, ChatGPT®, Gemini®, Claude®, Llama®, Ernie®, Grok®, etc.

At step 220, the generic language model may query a domain-specific knowledge model for an answer to the question. The domain-specific knowledge model may pertain to HVAC systems and therefore more provide specific answers associated with he HVAC systems.

At step 230, the answer may be provided to the user. In one or more embodiments, the answer may be provided in the user interface that the question came from. For example, if the user posed the question orally, the answer may be converted from text to speech to provide an oral answer to the user. In one or more embodiments, the answer may be in form a video, which may be in the form of an instruction video to resolve the question.

At step 240, the documentation associated with the answer may be provided to the user. The documentation may include, for example, a specific page of a manual of a specific HVAC equipment, images, text, and/or any other form of documentation.

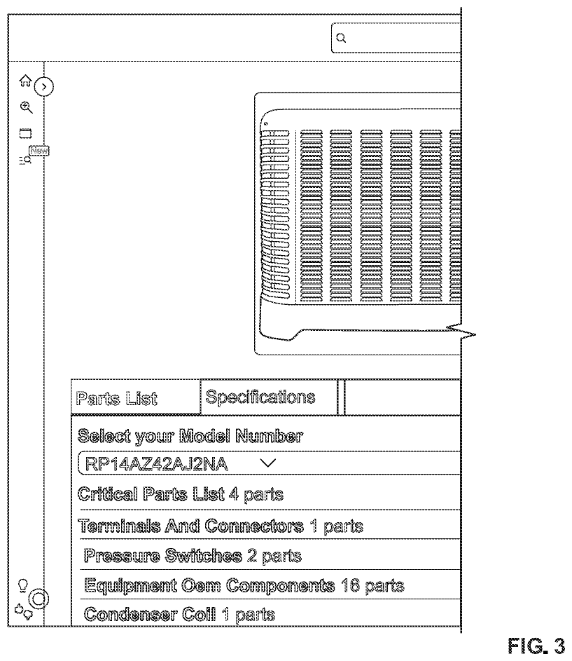

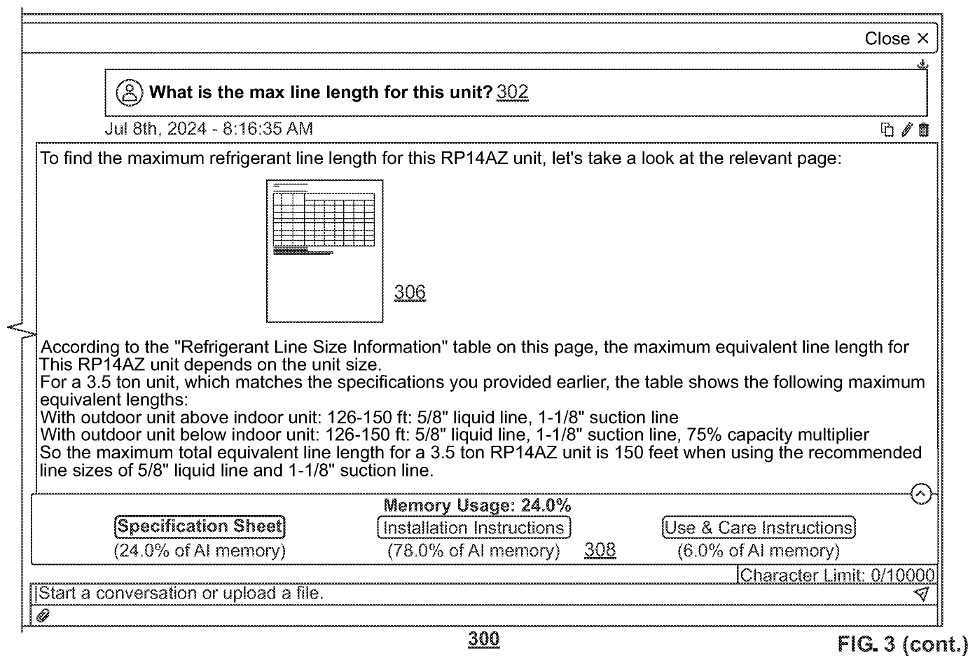

FIG. 3 shows an example interface 300 generated by the system 100 based on the principles disclosed herein. It should be understood that the interface 300 is just but an example and should not be considered limiting. As shown, the interface 300 includes a question 302 and a corresponding response 304 generated by the system 100. In addition to the response 304, the interface 300 shows a documentation 306 associated with the response 304. The interface 300 also provides options for the user to positional additional questions 308.

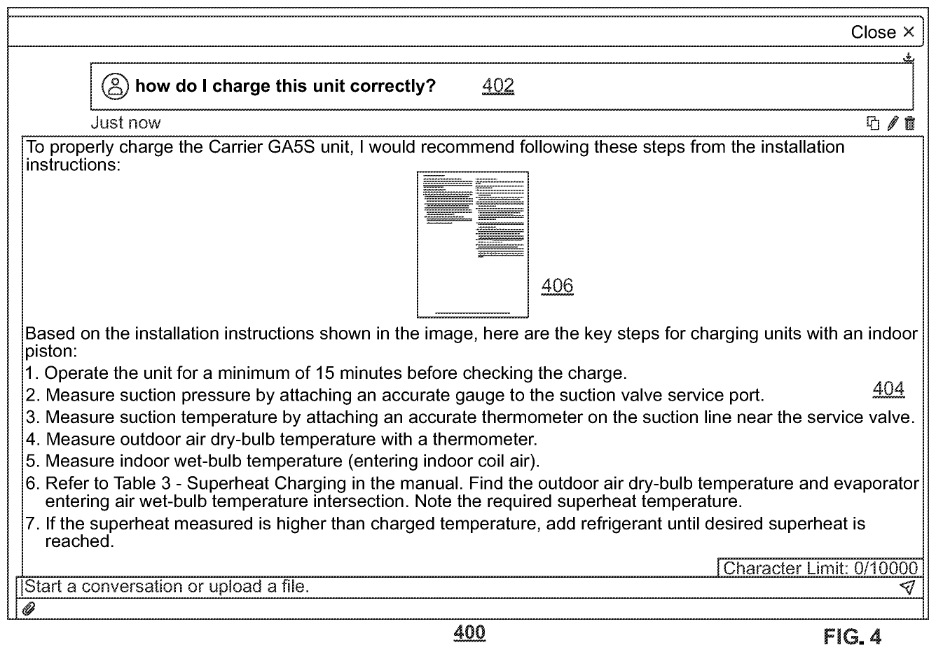

FIG. 4 shows an example interface 400 generated by the system 100 based on the principles disclosed herein. It should be understood that the interface 400 is just but an example and should not be considered limiting. As shown, the interface 400 includes a question 402 and a corresponding response 404 generated by the system 100. The interface 400 also shows a documentation 406 associated with the response 404.

Additional examples of the presently described method and device embodiments are suggested according to the structures and techniques described herein. Other non-limiting examples may be configured to operate separately or can be combined in any permutation or combination with any one or more of the other examples provided above or throughout the present disclosure.

It will be appreciated by those skilled in the art that the present disclosure can be embodied in other specific forms without departing from the spirit or essential characteristics thereof. The presently disclosed embodiments are therefore considered in all respects to be illustrative and not restricted. The scope of the disclosure is indicated by the appended claims rather than the foregoing description and all changes that come within the meaning and range and equivalence thereof are intended to be embraced therein.

It should be noted that the terms “including” and “comprising” should be interpreted as meaning “including, but not limited to”. If not already set forth explicitly in the claims, the term “a” should be interpreted as “at least one” and “the”, “said”, etc. should be interpreted as “the at least one”, “said at least one”, etc. Furthermore, it is the Applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

1. A system comprising:
a non-transitory storage medium storing computer program instructions; and
a processor configured to execute the computer program instructions to cause operations comprising:
receiving, by a generic language model, a question from a user;
querying, by the generic language model, a domain-specific knowledge model for an answer to the question;
providing the answer to the user; and
providing documentation associated with the answer to the user.

2. The system of claim 1, the domain-specific knowledge model comprising a knowledge model associated with an HVAC system.

3. The system of claim 1, the documentation comprising at least one of image, video, audio, diagram, or specification.

4. The system of claim 1, the operations further comprising:
providing the user with live expert support responsive to determining that the answer is unsatisfactory to the user.

5. The system of claim 1, at least a portion of the computer program instructions being executed on a computer, smartphone, or a tablet.

6. The system of claim 1, receiving the question from the user comprising:
receiving the question in a speech to text format.

7. The system of claim 1, providing the answer to the user comprising:
providing the answer in a text to speech format.

8. The system of claim 1, the operations further comprising:
storing the answer in a long term memory in response to determining that the answer was satisfactory to the user.

9. The system of claim 8, the operations further comprising:
enriching the domain-specific knowledge model using the answer in response to determining that the answer was satisfactory to the user.

10. The system of claim 1, the generic language model comprising a multi-modal large language model.

11. A processor implemented method comprising:
receiving, by a generic language model, a question from a user;
querying, by the generic language model, a domain-specific knowledge model for an answer to the question;
providing the answer to the user; and
providing documentation associated with the answer to the user.

12. The method of claim 11, the domain-specific knowledge model comprising a knowledge model associated with an HVAC system.

13. The method of claim 11, the documentation comprising at least one of image, video, audio, diagram, or specification.

14. The method of claim 11, further comprising:
providing the user with live expert support responsive to determining that the answer is unsatisfactory to the user.

15. The method of claim 11, at least a portion of the method being executed on a computer, smartphone, or a tablet.

16. The method of claim 11, receiving the question from the user comprising:
receiving the question in a speech to text format.

17. The method of claim 11, providing the answer to the user comprising:
providing the answer in a text to speech format.

18. The method of claim 11, further comprising:
storing the answer in a long term memory in response to determining that the answer was satisfactory to the user.

19. The method of claim 18, further comprising:
enriching the domain-specific knowledge model using the answer in response to determining that the answer was satisfactory to the user.

20. The method of claim 11, the generic language model comprising a multi-modal large language model.
